(19) United States
(12) Patent Application Publication
(10) Pub. No.: US 2019/0246607 A1
(43) Pub. Date: Aug. 15, 2019

(54) DOG COLLAR WITH A LIMITED TIGHTENING STRUCTURE

(71) Applicant: CHUNG-JENG CHEN, TAOYUAN CITY (TW)

(72) Inventor: CHUNG-JENG CHEN, TAOYUAN CITY (TW)

(21) Appl. No.: 15/895,128

(22) Filed: Feb. 13, 2018

(51) Int. Cl. A01K 27/00

(52) U.S. Cl. CPC A01K 27/005; A01K 27/003; A01K 27/002; A01K 27/001

(57) ABSTRACT

An adjustable dog collar with a breadth that is placed around necks of dogs and has a ladder lock buckle thereof positioned right under their jaws. The collar further has a first and second straps, each has an adjustable diameter to ensure the dog collar would not slip down from the necks of dogs and would not be tightened unlimitedly. Thereby the dog collar prevents suffocation and tracheary injuries of dogs and enables easier control of dogs with less strength needed from the dog owners.

### BACKGROUND OF THE INVENTION

### 1. Field of the Invention

The present invention relates to a dog collar, particularly to one that has an adjustable structure by diameters of straps and would not be tightened unlimitedly.

### 2. Description of the Related Art

Dogs are man's best friend, but they are also carnivores with sharp teeth. Therefore in many countries it is legally regulated to put on dog collars when taking the dogs outdoors for the purpose of precaution. However, sudden uncontrolled actions of the dogs happen now and then due to various reasons such as excitement, nervousness, territorial issues, unfamiliarity of the environment or people around . . . , etc. Such actions can lead to dangerous situations such that people may get frightened or get hurt and that the dogs may get unleashed and run into anything on the roads, resulting in even worse incidents; also, the dogs themselves can get hurt too.

In order to prevent from the situations as mentioned, there are tools brought in use on dogs. For instance, a conventional P-leash 10 is shown in FIG. 1. The P-leash 10 has a rope 11 threaded through a connecting ring 12 to be put around the neck of dogs, forming a leash in a P shape. Another conventional P-leash 20 is shown in FIGS. 2A and 2B. The P-leash 20 includes a belt 21 with a buckle 22 for the P-leash 20 to be adjustable in order to be put on the neck of dogs near the shoulders as shown in FIG. 2B. The P-leash 20 further has a chain 23 with a ring 24 threaded through a free end of the chain 23 to form a circle 25 to be put on the neck of dogs, and a plurality of connecting element 26 connecting periphery of the circle 25 and the belt 21 in a distance. Such structures have been disclosed in U.S. Pat. Nos. 4,022,161 and 3,974,800.

The inventor has a sheepdog which has been having issues of sudden uncontrolled actions, thus the inventor has been searching for solutions to the issues, including the use of mentioned tools and turning to professionals for advice. During the process, it has become obvious that conventional dog collars can hurt the dogs' trachea. Take the conventional P-leashes 10, 20 for example. When the owner is pulling the P-leash 10, 20 and creating a pulling force F, the leash 10, 20 would be tightened as shown in FIG. 3C; consequently, the tightened leash 10, 20 could cause tracheary injuries, coughing, or even suffocation for dogs. More importantly, it is not humanitarian.

On the other hand, martingale collars are adjustable and comparatively easier for putting on and taking off the collar. It would not be tightened excessively, but there is still possibility of tracheary injuries. Or there are dog harnesses designed for tracheary protection, but dog harnesses were originally designed for pulling or hauling; therefore it is even easier for the dogs to make a habit of having sudden uncontrolled actions when they feel like to do so. In some types of dog harness, the dogs can get twined by the leash, making it troublesome to untwine the dogs and lead the dogs to a desirable direction.

Another tool is the gentle leader head collars. It can protect the dog's trachea and also improve their habit of sudden uncontrolled actions, and it provides an easier way to guide the dogs in a desirable direction. However, it is not comfortable for the dogs to wear on and the dogs would keep trying to get rid of the head collars.

Moreover, there are a few points coming to our attention in solving the problems stated above. The points are described in the following.

1. The neck of dogs has different diameters at different end in a shape similar with a traffic cone; the end near the jaw of the dogs has a shorter diameter and the end near the shoulders of the dogs has a longer diameter. Usually the dog collars are put slightly loose around the neck of the dogs, and with the different diameters of their necks, the dogs can take off their collars without much effort. Also, due to the different diameters of the necks, the dog collars are tighter when slipping down from the dogs' neck and looser when the dog collars are displaced upwardly. Conventionally, dog collars are arranged with a width less than 3 cm, and the wider the dog collar is, the looser it is around the upper section of the neck of dogs.

2. When a dog collar is close to the jaw of dogs, the bones and muscles around the jaw would share most of the pressure from the collar to prevent from injuries. If we surround out necks with our hands and try to put pressure on the neck, it is very uncomfortable. Therefore we can presume that dogs would feel the same way when their necks are pressured by their collars, especially when they are acting sudden uncontrolled behaviors.

3. The dog collars and the leash basically function similarly with a lever. The chest of dogs regarded as the fulcrum, the nearer the collar is to the jaw of the dogs, the angle between the leash and the dog's body is wider and the less strength needed for guiding the dog.

Taking the problems stated above into consideration, the inventor has come up with a solution—to position a part of the dog collar right under the jaw of dogs, since the difference between the upper and lower diameters of dogs' necks is less than the diameters between the jaw and the chest of dogs.

### SUMMARY OF THE INVENTION

A primary objective of the present invention is to provide a dog collar that is not tightened unlimitedly to avoid suffocation and tracheary injuries of dogs.

Another objective of the present invention is to provide a dog collar that enables dog owners to hold control of their dogs with little strength effectively.

To achieve the objectives mentioned above, the present invention comprises an adjustable collar including an upper end and a lower end, said upper and lower end arranged in a distance of at least 3 cm to form the collar with a breadth; a ladder lock buckle arranged at least 3 cm high and including a first slot, a second slot, a third slot, and a fourth slot each at a corner thereof, said first slot at an upper-left corner, said second slot at an upper-right corner, said third slot at a lower-left corner, said fourth slot at a lower-right corner, thereby when said collar is put on a dog, said ladder lock buckle is positioned right below a jaw of the dog; a second strap threaded through the third and fourth slot of the ladder lock buckle vertically and has both ends thereof threaded onto a corresponding end of a fastening element, said second strap further threaded through an adjusting element for adjustment of a diameter of the collar, thereby the second strap is positioned near shoulders of a dog without slipping down; a first strap having a first end threaded and fixed onto the first slot of the ladder lock buckle and a second end threaded through the second slot of the ladder lock buckle as a free end for the first strap to be vertically engaged with the ladder lock buckle, thereby the first strap is positioned around a jaw of a dog when the collar is put on; a displaceable first stopper arranged on the first strap near the second slot of the ladder lock buckle to adjust a diameter of an opening formed by the first strap; and a connecting strap extending from and formed by the second end of the first strap after the second end is threaded through the second slot, thereby said connecting strap is controlled based on a fulcrum that is not a point of balance on said collar.

Whereby the connecting strap is controlled based on the second slot as a fulcrum and the first and second straps each has an adjustable diameter so that the second strap is positioned at a pre-determined place around a neck of a dog without slipping down and that the first strap is positioned right under a jaw of a dog and has the first stopper confines a tightening degrees of the first strap; therefore the collar would not be tightened unlimitedly.

Furthermore, a second stopper is threaded through the connecting strap and positioned at an outer side of the second slot; said second stopper allowing the first strap to be adjustable and confining the diameter of the first strap. The first, second, third, and fourth slots are formed on the ladder lock buckle in one piece. The first stopper is a triglide buckle and a fixed bar in a middle of the triglide buckle further includes at least one ridge to prevent from slipping of the first strap when it is threaded through the first stopper. In addition, the fastening element is a side-release buckle and the adjusting element is a triglide buckle, and the connecting strap further has a connecting ring for connection with a leash arranged at a pre-determined length.

With structures disclosed above, the present invention provides a comfortable and protective collar for dogs. The collar serves as an effective tool to hold control of the dogs for their owners and avoids sudden uncontrolled behaviors of the dogs.

### BRIEF DESCRIPTION OF THE DRAWINGS

FIG. 1 is a schematic diagram illustrating a leash connected with a ring according to the prior art;

FIG. 2A is a perspective view of a conventional P-collar

FIG. 2B is a practical application view of a conventional P-collar;

FIG. 2C is a schematic diagram illustrating a conventional P-collar being tightened unlimitedly;

FIG. 3A is a perspective view of a ladder lock buckle of the present invention;

FIG. 3B is a top plan view of the ladder lock buckle of the present invention;

FIG. 3C is a front elevation view of the ladder lock buckle of the present invention;

FIG. 4A is a perspective view of the present invention;

FIG. 4B is another perspective view of the present invention viewing from another angle;

FIG. 4C is a schematic diagram illustrating structure of a stopper of the present invention;

FIG. 4D is a schematic diagram illustrating structure of a fastening element of the present invention;

FIG. 5 is a front elevation view of the present invention;

FIG. 6A is a top plan view of the present invention;

FIG. 6B is a top plan view of the present invention illustrating a collar thereof being fixed in a position by a stopper thereof;

FIG. 7A is a practical application view illustrating the present invention put around the neck of a dog; and

FIG. 7B is a schematic diagram illustrating the present invention put around the neck of a dog and would not be tightened unlimitedly.

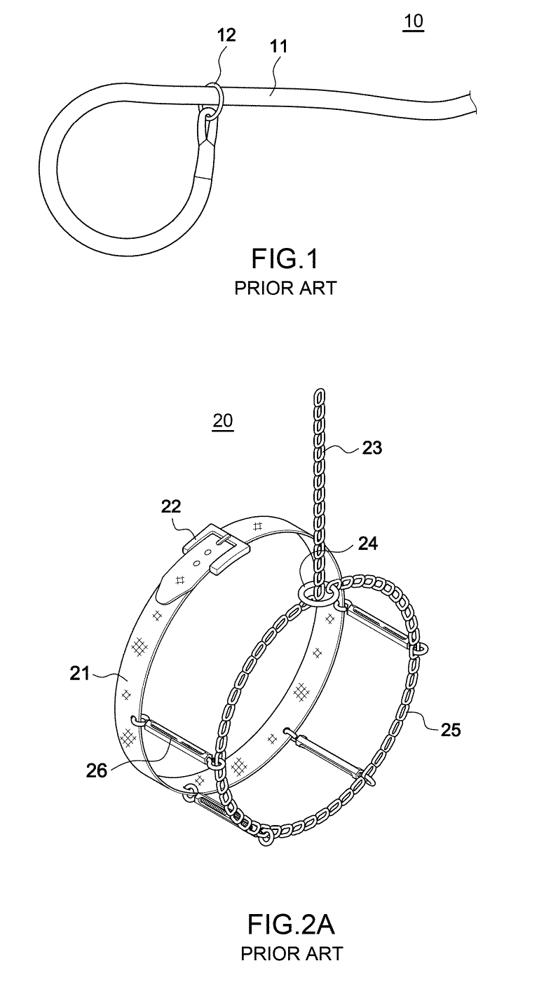

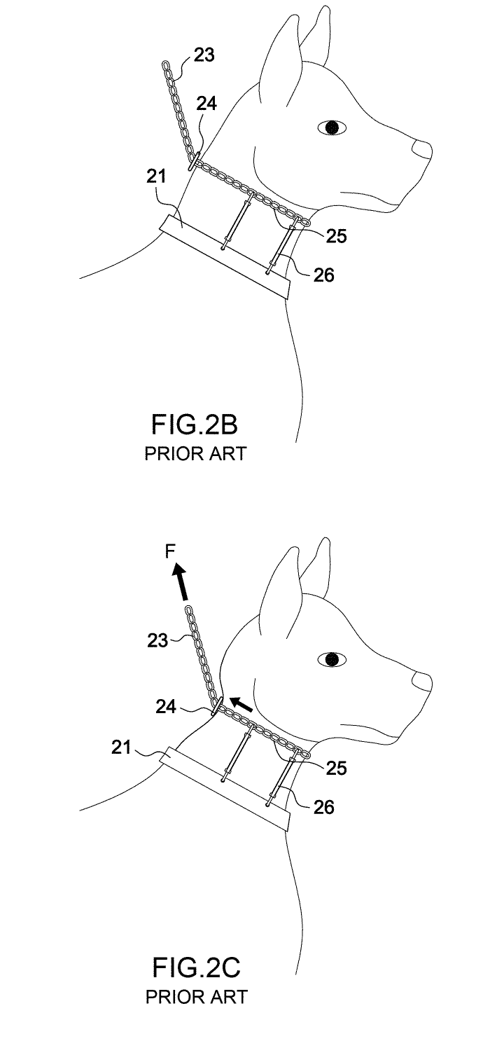

### DETAILED DESCRIPTION OF THE PREFERRED EMBODIMENT

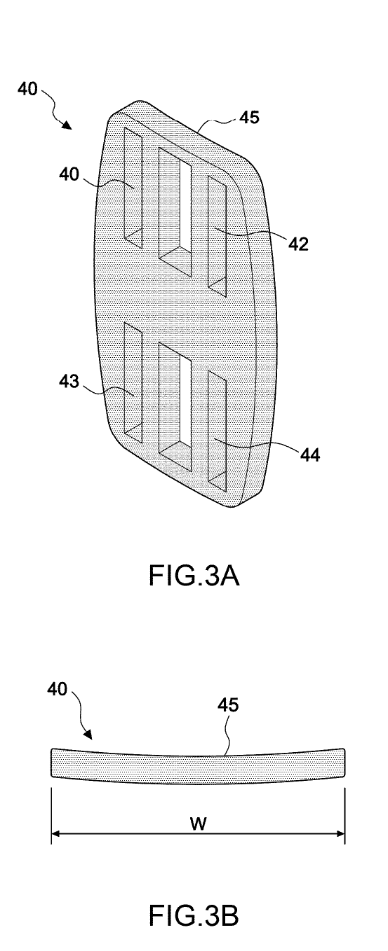

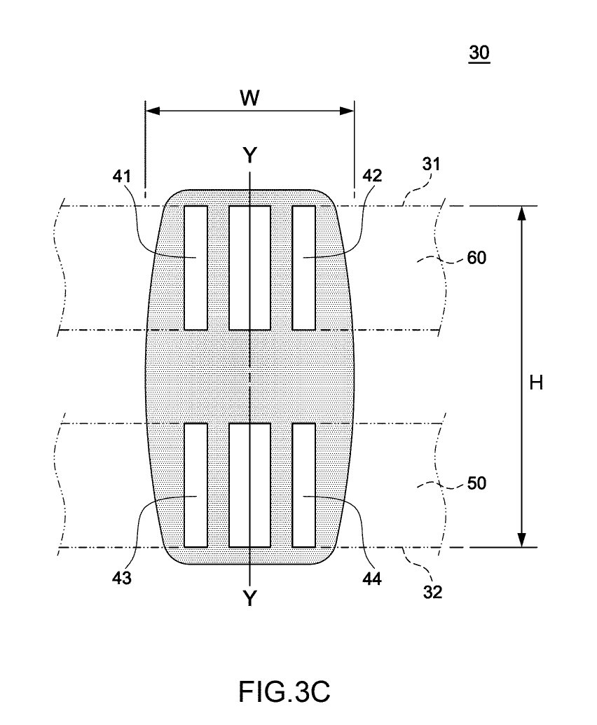

Referring to FIGS. 3A-7B, the present invention in a preferred embodiment comprises a collar 30, a ladder lock buckle 40, a first strap 60, a second strap 50, and a connecting strap 70.

The collar 30 includes an upper end 31 and a lower end 32 arranged in a distance of at least 3 cm to form a breadth in-between, and the diameter of the collar 30 is thereby adjustable as shown in FIG. 3C for which to be put on the neck of dogs.

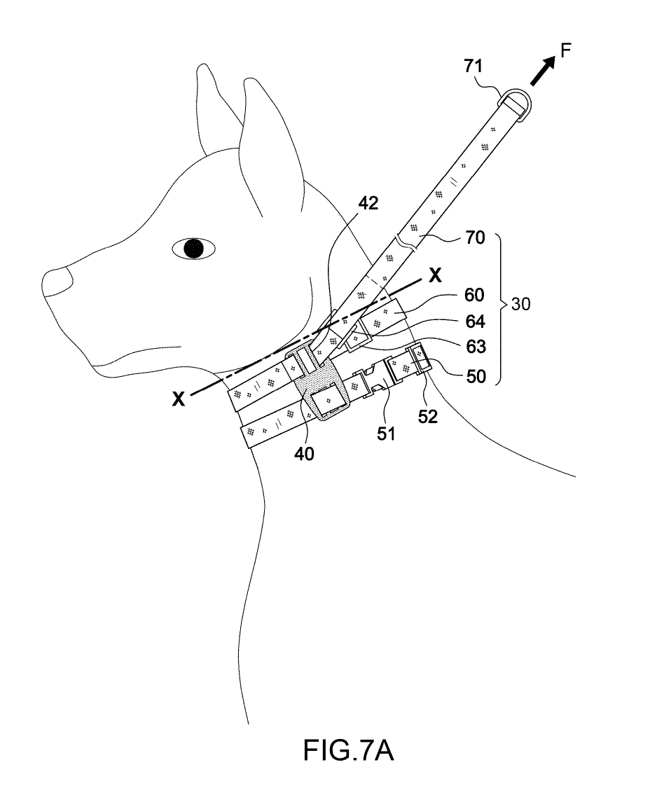

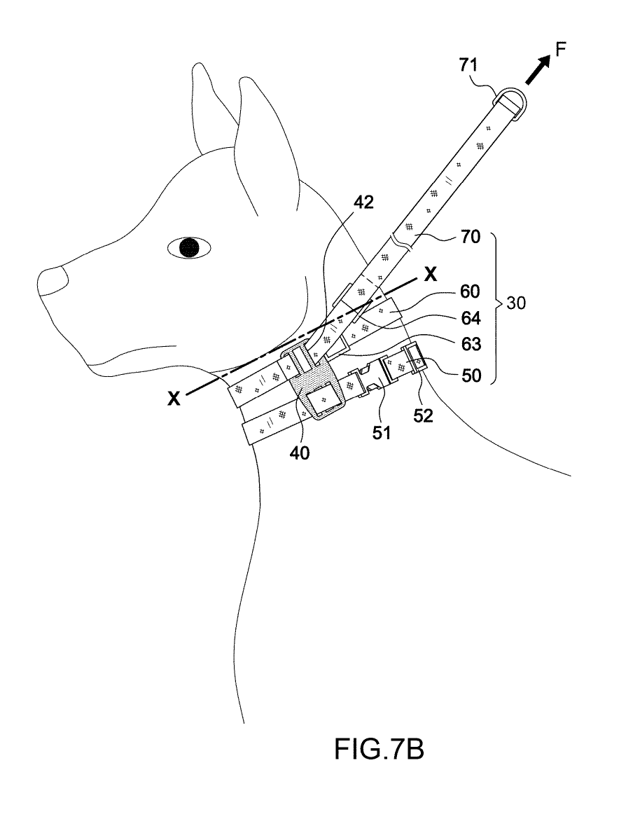

Referring to FIGS. 3A-3C, the ladder lock buckle 40 is arranged at least 3 cm high and includes a first slot 41, a second slot 42, a third slot 43, and a fourth slot 44. The first slot 41 is arranged at the upper-left corner of the ladder lock buckle 40; the second slot 42 is arranged at the upper-right corner; the third slot 43 is arranged at the lower-left corner; and the fourth slot 44 is arranged at the lower-right corner. Thereby when the collar 30 is put on the neck of dogs, the ladder lock buckle 40 is positioned right below the jaw of the dogs parallel with an X-X axis as shown in FIG. 7A. In this embodiment, the ladder lock buckle 40 is arranged at a height H between 5-7 cm and a width W between 3-5 cm. but it is not limited to such application. In addition, the ladder lock buckle 40 is arranged in a shape of slight curve 45 in accordance with the shape of dogs' neck. In the embodiment, the first, second, third, and fourth slots 41, 42, 43, 44 are formed on the ladder lock buckle 40 in one piece, but they are not limited to such application. The slots can be arranged as engaging holes or D-rings aside the ladder lock buckle 40.

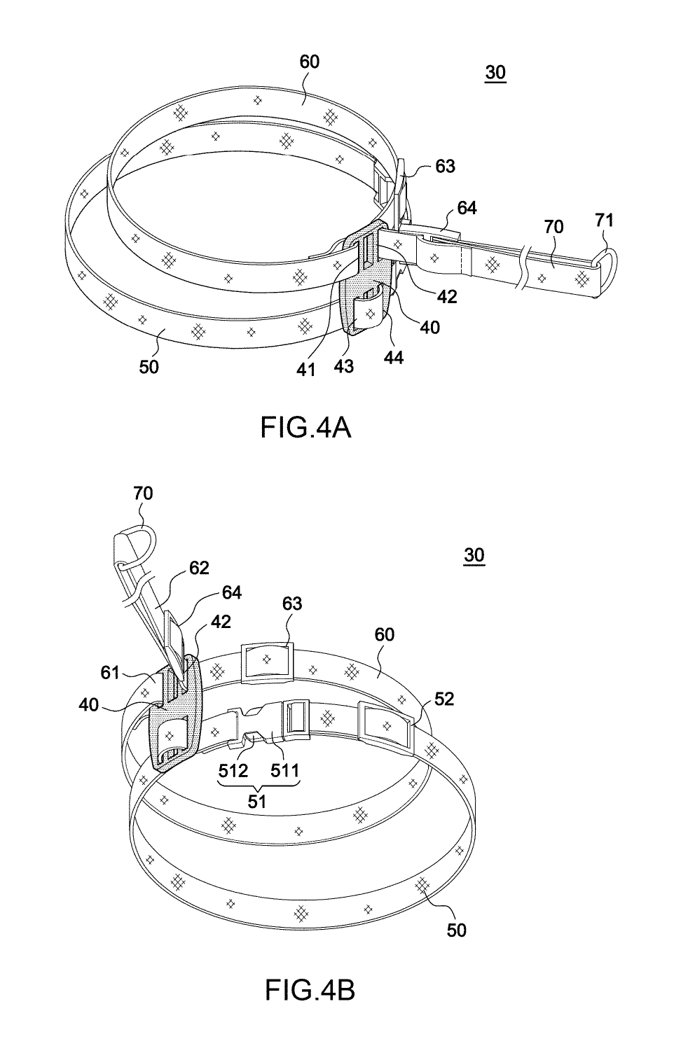

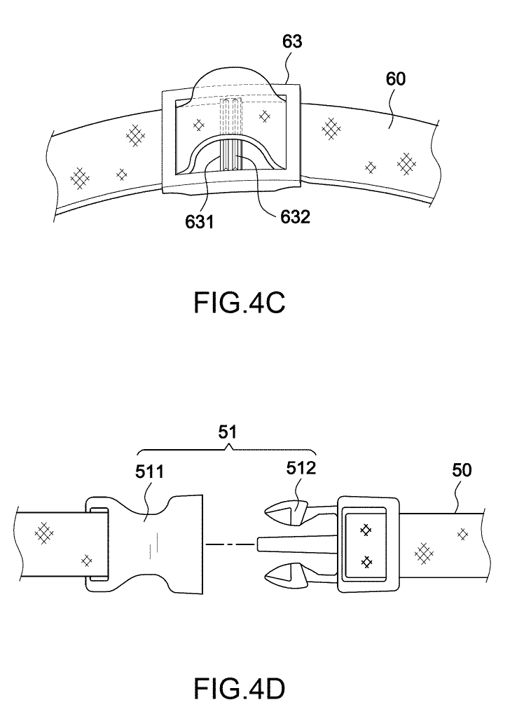

Further referring to FIGS. 4A and 4B, the second strap 50 is threaded through the third and fourth slot 43, 44 of the ladder lock buckle 40 vertically and each end of the second strap 50 is threaded onto an end of a fastening element 51. The second strap 50 is further threaded through an adjusting element 52 for adjustment of a diameter D of the second strap 50, thereby the second strap 50 can be positioned near the shoulders of dogs without slipping down. In the embodiment, the fastening element 51 is a conventional side-release buckle as shown in FIG. 4C, including a female portion 511 and a male portion 512 to easily buckle up and form the collar 30, and the adjusting element 52 is a conventional triglide buckle as shown in FIG. 4B. However, neither the fastening element 51 nor the adjusting element 52 is limited to such application. Both of them can be press release buckles or belt buckles.

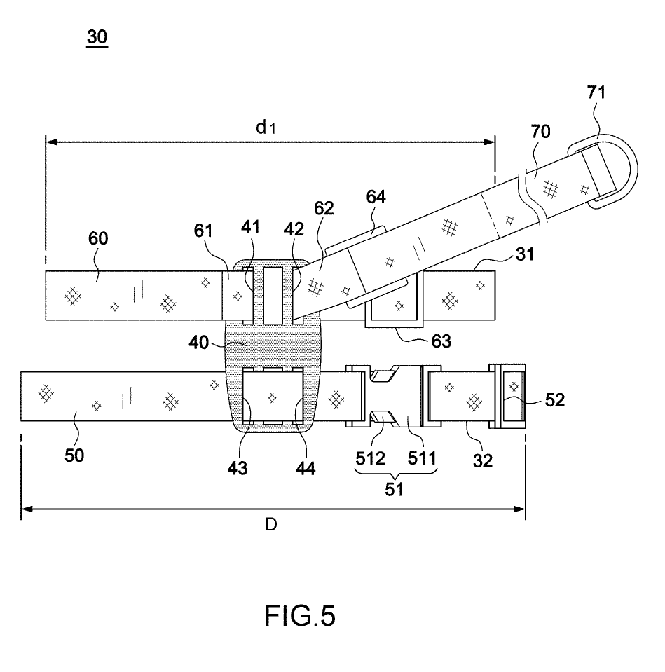

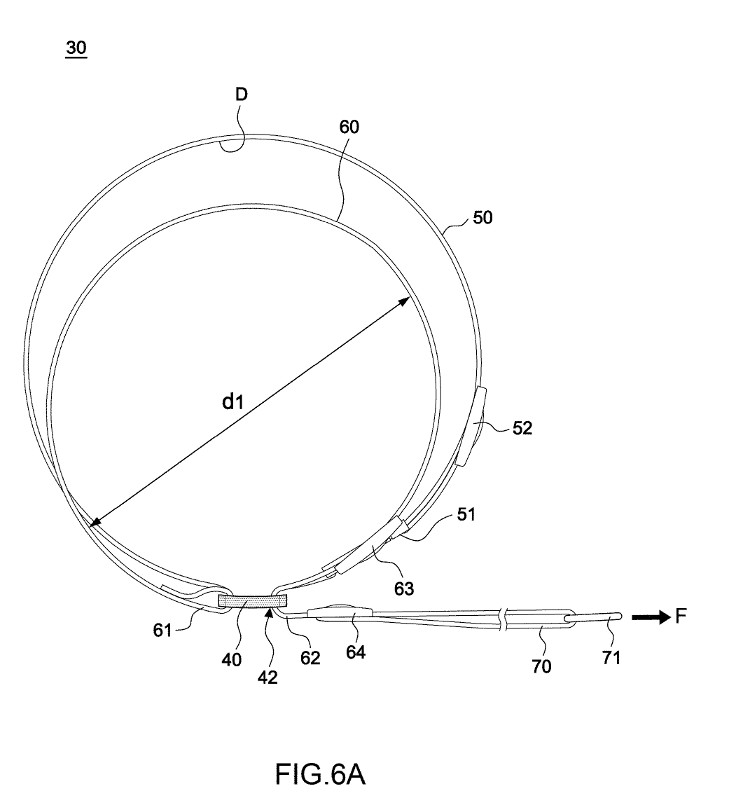

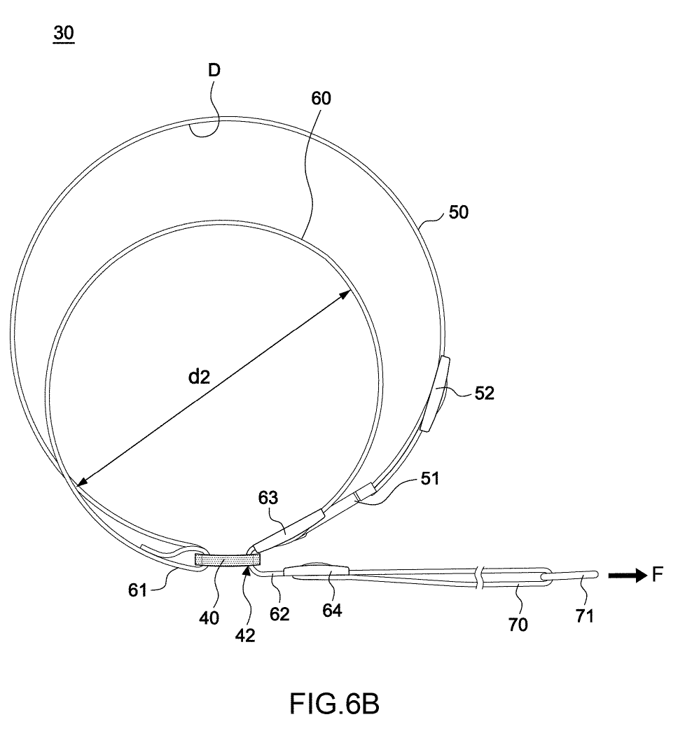

The first strap 60 has a first end 61 threaded and fixed onto the first slot 41 of the ladder lock buckle 40 and a second end 62 threaded through the second slot 42 of the ladder lock buckle 40 as a free end for the first strap 60 to be vertically engaged with the ladder lock buckle 40 as shown in FIGS. 5 and 6A, thereby the first strap 60 is formed with a pre-determined diameter d1 and positioned around the jaw of dogs when the collar 30 is put on. In this embodiment, the first end 61 is fixed onto the first slot 41 by sewing machines or rivets. A displaceable first stopper 63 is arranged on the first strap 60 near the second slot 42 of the ladder lock buckle 40 for dog owners to adjust the diameter d1 of the first strap 60 as shown in FIG. 5. In this embodiment, the first stopper 63 is a conventional triglide buckle as shown in FIG. 4C; a fixed bar 631 in a middle of the triglide buckle 63 further includes at least one ridge 632 to prevent from slipping of the first strap 60 when it is threaded through the first stopper 63.

The connecting strap 70 is formed by the second end 62 of the first strap 60, extending after being threaded through the second slot 42, thereby the connecting strap 70 is controlled based on a fulcrum that is not a point of balance on the collar 30; the point of balance is lies along an Y-Y axis as shown in FIG. 3C. In addition, the connecting strap 70 can be further extended in length if needed or has a connecting ring 71 to further connecting to a leash (not shown).

Thereby the connecting strap 70 is controlled based on the second slot 42 as a fulcrum when receiving a pulling force as shown in FIG. 5; the collar 30 is positioned right under the jaw of dogs; and the diameters d1, D of the first and second straps 60, 50 can be adjusted to ensure that the second strap 50 would not slip down unlimitedly. Besides, the first strap 50 has the first stopper 63 confining the tightening degrees thereof around the neck of dogs, so as to ensure that the collar 30 would not be tightened unlimitedly. FIG. 7A shows the collar 30 put on a dog and FIG. 7B illustrates the collar 30 held in position without being tightened unlimitedly.

In this embodiment, a second stopper 64 is threaded through the connecting strap 70 and adjustably positioned at an outer side of the second slot 42 in order to confine the diameter d1 of the first strap 60 as shown in FIG. 6A and prevent it from loosening or slipping down. FIG. 6B shows a top plan view of the present invention with the first strap 60 fixed in a position by the first stopper 63, forming a smallest number of a diameter d2, so that the first strap 60 would not be tightened unlimitedly and the first stopper 63 enables users to adjust the diameter d2 of the first stopper 63 as needed.

All in all, the present invention has features stated as following.

1. The ladder lock buckle 40 is designed in a shape according to shapes of dogs' neck as the major component of the present invention and is threaded by the first and second straps 60, 50, forming an adjustable collar that would not be tightened unlimitedly. The diameter D of the second strap 50 is designed to be positioned at a pre-determined place around the neck of dogs for the first strap 60 to be positioned right under the jaw of the dogs, and the design is suitable for various kinds of dogs. In addition, the connecting strap 70 is controlled based on the second slot 42 of the ladder lock buckle 40 which is a fulcrum that is not the point of balance, providing a more efficient and easier way of control for dog owners in comparison to conventional dog collars controlled based on a D ring which, meanwhile, is the point of balance.

2. The ladder lock buckle 40 is further designed to have a height of 3-12 cm. In this embodiment, the ladder lock buckle 40 is 5-cm high and 3-cm wide as shown in FIGS. 3B and 3C, but it is not limited to such application. The height and width should be arranged in accordance with different kinds of dogs, thereby provide more protection from tracheary injuries for the dogs and easier control of the dogs for their owners.

3. The collar 30 has the first and second straps 60, 50 individually threaded through the ladder lock buckle 40 featuring an easily worn function of the present invention, allowing the dog owners to conveniently put on and take off the collar 30 within a short period of time.

4. The first stopper 63 confines the diameters d1, D or the first and second straps 60, 50 to ensure the collar 30 will not be tightened unlimitedly to result in tracheary injuries or suffocation of the dogs; and the second stopper 64 further confines the maximum number of the diameter of the first strap 60 to prevent from slipping down and loosening from the neck of dogs and to enhance the stability of control for the dog owners as well.

In short, the present invention combines advantages of conventional dog collars and even provides a more comfortable and protective dog collar that functions efficiently in controlling the dogs.

What is claimed is:

1. A dog collar with a limited tightening structure, comprising:
an adjustable collar including an upper end and a lower end, said upper and lower end arranged in a distance of at least 3 cm to form the collar with a breadth;
a ladder lock buckle arranged at least 3 cm high and including a first slot, a second slot, a third slot, and a fourth slot each at a corner thereof, said first slot at an upper-left corner, said second slot at an upper-right corner, said third slot at a lower-left corner, said fourth slot at a lower-right corner, thereby when said collar is put on a dog, said ladder lock buckle is positioned right below a jaw of the dog;
a second strap threaded through the third and fourth slot of the ladder lock buckle vertically and has both ends thereof threaded onto a corresponding end of a fastening element, said second strap further threaded through an adjusting element for adjustment of a diameter of said second strap, thereby the second strap is positioned near shoulders of a dog without slipping down;
a first strap having a first end threaded and fixed onto the first slot of the ladder lock buckle and a second end threaded through the second slot of the ladder lock buckle as a free end for the first strap to be vertically engaged with the ladder lock buckle, thereby the first strap is positioned around a jaw of a dog when the collar is put on;
a displaceable first stopper arranged on the first strap near the second slot of the ladder lock buckle to adjust a diameter of an opening formed by the first strap; and
a connecting strap extending from and formed by the second end of the first strap after the second end is threaded through the second slot, thereby said connecting strap is controlled based on a fulcrum that is not a point of balance on said collar;
whereby the connecting strap is controlled based on the second slot as a fulcrum and the first and second straps each has an adjustable diameter so that the second strap is positioned at a pre-determined place around a neck of a dog without slipping down and that the first strap is positioned right under a jaw of a dog and has the first stopper confines a tightening degrees of the first strap; therefore the collar would not be tightened unlimitedly.

2. The dog collar with a limited tightening structure e as claimed in claim 1, further comprising a second stopper threaded through the connecting strap and positioned at an outer side of the second slot, said second stopper allowing the first strap to be adjustable and confining the diameter of the first strap to prevent the first strap from loosening around a neck of a dog.

3. The dog collar with a limited tightening structure as claimed in claim 2, wherein the second stopper is a triglide buckle.

4. The dog collar with a limited tightening structure as claimed in claim 1, wherein the first stopper is a triglide buckle and a fixed bar in a middle of the triglide buckle further includes at least one ridge to prevent from slipping of the first strap when it is threaded through the first stopper.

5. The dog collar with a limited tightening structure as claimed in claim 1, wherein the first, second, third, and fourth slots are formed on the ladder lock buckle in one piece.

6. The dog collar with a limited tightening structure as claimed in claim 1, wherein the fastening element is a side-release buckle and the adjusting element is a triglide buckle.

7. The dog collar with a limited tightening structure as claimed in claim 1, wherein the connecting strap further has a connecting ring for connection with a leash arranged at a pre-determined length.
